(19) United States
(12) Patent Application Publication
(10) Pub. No.: US 2006/0029163 A1
(43) Pub. Date: Feb. 9, 2006

(54) FREQUENCY BURST DETECTOR AND RELATED DETECTION METHOD THEREOF

(76) Inventors: Shih-Yang Yang, Taipei Hsien (TW); WEI-SHUN LIAO, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,583

(22) Filed: Aug. 9, 2005

(30) Foreign Application Priority Data
Aug. 9, 2004 (TW) 093123846

(51) Int. Cl. H04L 27/06; H04B 1/10

(52) U.S. Cl. 375/340; 375/349

(57) ABSTRACT

A receiving apparatus for receiving a signal is disclosed. The receiving apparatus includes a first block power calculator for evaluating a plurality of block powers of the signal, a band pass filter for filtering the signal and outputting a specific frequency component of the signal, a second block power calculator for evaluating a plurality of band-passed block powers corresponding to an output signal of the band pass filter, a median filter module for outputting a first block power according to the plurality of block powers and for outputting a first band-passed block power according to the plurality of band-passed block powers, and a frequency burst acquisition module for determining if the signal comprises a frequency burst signal according to the first block power and for controlling the receiving apparatus to synchronize the signal.

### BACKGROUND OF THE INVENTION

1. Field of the Invention

The invention relates to a receiving apparatus and related method, and more particularly, to a receiving apparatus capable of detecting frequency burst signals, and a related detection method thereof.

2. Description of the Prior Art

The packet of Time Division Multiple Access (TDMA) system comprises a series of burst preamble for synchronizing a carrier frequency and receiving timing of a transmitter and receiver, in order to make the receiver read each set of packet data precisely. The above-mentioned process is called synchronization. Consequently, the receiver starts to synchronize after receiving the series of burst preamble, ensuring the quality of data.

Taking Global Systems for Mobile communications (GSM) as an example, the above-mentioned burst preamble is a frequency burst (FB) signal, which is transferred into a pure tone signal by modulation of the FB signal with Gaussian Minimum Shift Keying (GMSK). As a result, a prior art frequency burst detector uses band pass filters to filter the pure tone signal and evaluate a block power of the pure tone signal. When the block power reaches a threshold value, the frequency burst detector determines that an FB signal has been received, and then drives the receiver to synchronize. Please refer to FIG. 1, which is a functional block diagram of a prior art frequency burst detector 10. The prior art frequency burst detector 10 comprises a plurality of block power calculators 12 and 16, a band pass filter 14, and an FB acquisition module 18. The block power calculator 12 is used for evaluating the block power P_{S} of a received signal S, and the band pass filter 14 is used to filter the received signal S to generate a specific frequency component A of the received signal S. The block power calculator 16 is used to evaluate the block power P_{A} of the specific frequency component A. Please note that the specific frequency component A relates to the frequency of the above-mentioned pure tone signal generated by the GMSK modulation. As a result, the specific frequency component A outputted by the band pass filter 14 is similar to an FB signal. The frequency burst acquisition module 18 computes a ratio of the block powers P_{A} and P_{S} outputted by the block power calculators 16 and 12 respectively. When the ratio of the block power P_{A} to P_{S} (abbreviated to R_{A,S}) is greater than a threshold value, the block power P_{A} is significantly larger than normal block power P_{A}. The frequency burst acquisition module 18 determines that the received signal comprises a frequency burst signal when the ratio of the block power P_{A} to P_{S} is greater than a threshold value, and drives the receiver to synchronize. The prior art frequency burst detector 10 often gives a false alarm because of some non-frequency-burst (non-FB) signals, such as SB signals or BCCH signals. These non-FB signals also have a high power in the frequency of the specific frequency component and are therefore conceived to be FB signals by the frequency burst acquisition module 18.

Please refer to FIG. 2, which is an operation schematic diagram of the frequency burst acquisition module 18 shown in FIG. 1. The received signal S relates to a frequency burst signal in the time interval t1, and relates to non-FB signals in the time intervals t2 and t3. Because the non-FB signals are composed of several impulse signals all having high power, the output signal of the band pass filter 14 shown in FIG. 1 corresponding to the non-FB signal also has a high power. The frequency burst acquisition module 18 compares the ratio R_{A,S} with a threshold value Rₜₕ in the time intervals t2 and t3. As a consequence of the high power of the non-FB signal, the frequency burst acquisition module 18 incorrectly determines that the received signal S comprises a frequency burst signal. In this case, the frequency burst acquisition module 18 will mistakenly drive the receiver to synchronize.

### SUMMARY OF THE INVENTION

It is therefore one objective of the claimed invention to provide an improved frequency burst detector capable of discarding the non-FB signal, in order to solve the above-mentioned problem.

It is another objective of the claimed invention to provide a signal synchronization method capable of avoiding the influence of the non-FB signal.

According to the claimed invention, a receiving apparatus for receiving a signal is disclosed. The receiving apparatus comprises a first block power calculator for evaluating a plurality of block powers of the signal, a band pass filter for filtering the signal and outputting a specific frequency component of the signal, a second block power calculator, electrically connected to the band pass filter, for evaluating a plurality of band-passed block powers corresponding to an output signal of the band pass filter, a median filter module, electrically connected to the first and the second block power calculators, for outputting a first block power according to the plurality of block powers and for outputting a first band-passed block power according to the plurality of band-passed block powers, and a frequency burst acquisition module, electrically connected to the median filter module, for determining if the signal comprises a frequency burst signal to control the receiving apparatus to synchronize the signal.

According to the claimed invention, a signal synchronization method of a receiving apparatus is disclosed. The method comprises (a) evaluating a plurality of block powers according to a received signal, (b) band-pass filtering the received signal for generating a specific frequency component of the received signal, (c) evaluating a plurality of band-passed block powers according to the specific frequency component, (d) generating a first block power according to the plurality of block powers, and generating a first band-passed block power according to the plurality of band-passed block powers, and (e) determining if the received signal comprises a frequency burst signal according to the first block power and the first band-passed block power to control the receiving apparatus to synchronize the signal.

The frequency burst detector in the present invention utilizes a median filter module to filter out the non-FB signal, so as to decrease the probability of false alarms, and improve the performance of the receiver without frequent synchronization.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a prior art frequency burst detector.

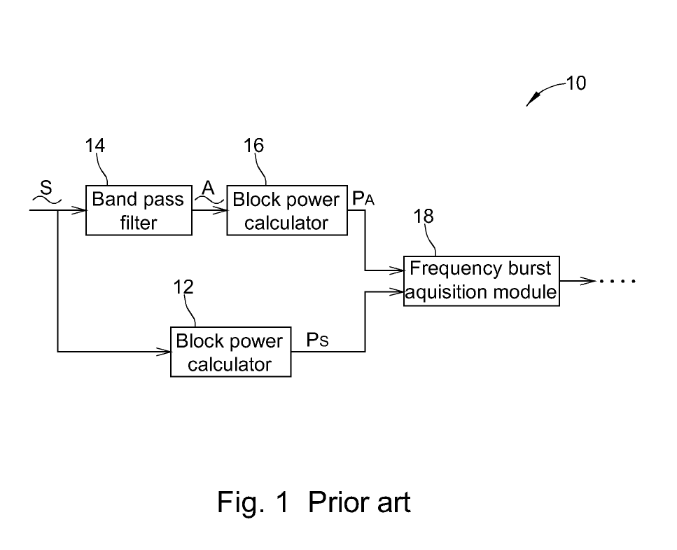

FIG. 2 is a schematic diagram showing the operation of a prior art frequency burst detector in FIG. 1.

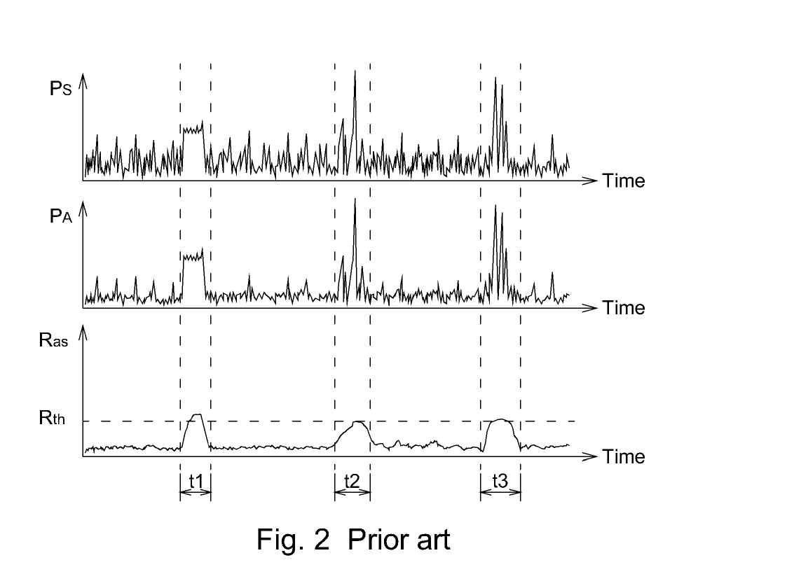

FIG. 3 is a functional block diagram of an embodiment of a frequency burst detector in the present invention.

FIG. 4 is a schematic diagram showing a sliding window used by the media filter shown in FIG. 3.

FIG. 5 is a schematic diagram showing the operation of a media filter in FIG. 3.

### DETAILED DESCRIPTION

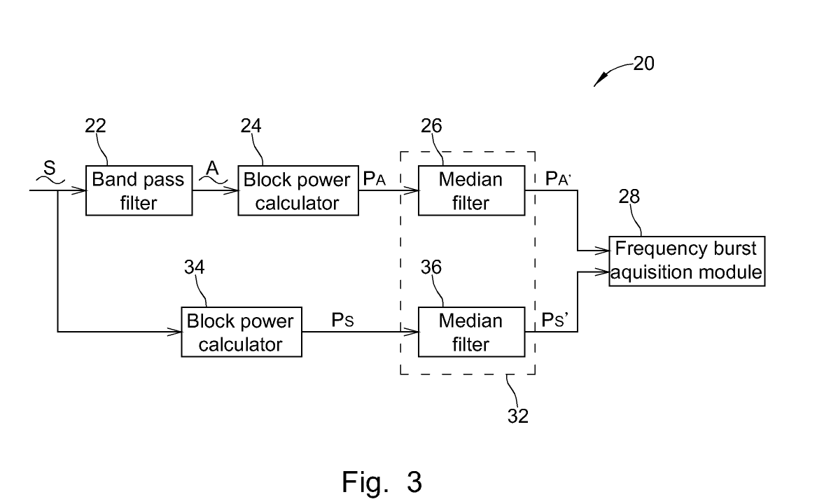

Please refer to FIG. 3, which is a functional block diagram of an embodiment of the frequency burst detector 20 in the present invention. The frequency burst detector 20 is a receiving apparatus applied in a Time Division Multiple Access (TDMA) system, such as Global System for Mobile communications (GSM). In the present embodiment, the frequency burst detector 20 comprises a band pass filter 22, two block power calculators 24 and 34, a median filter module 32, and a frequency burst acquisition module 28. The median filter module 32 comprises two median filters 26 and 36 electrically connected to the block power calculators 24 and 34 respectively. The block power calculator 34 is used to evaluate the block power P_{S} of the received signal S. The band pass filter 22 is used to filter the received signal S according to a specific frequency range, and generate a frequency component A. Please note that the specific frequency range matches the frequency range of the frequency burst signal, hence the band pass filter 22 picks the frequency component A to be similar to the frequency burst signal from the received signal S. Then, the block power calculator 24 evaluates the block power P_{A} of the frequency component A outputted by the band pass filter 22, and the block power calculator 34 evaluates the block power P_{S} of the received signal S. The median filters 26 and 36 process the input signals (i.e., block powers P_{A} and P_{S}) and respectively generate the output signals P_{A}′ and P_{S}′. Finally, the frequency burst acquisition module 28 computes a ratio of the block power P_{A}′ to the block power P_{S}′, and determines that the received signal S is a frequency burst signal if the ratio is greater than a threshold value.

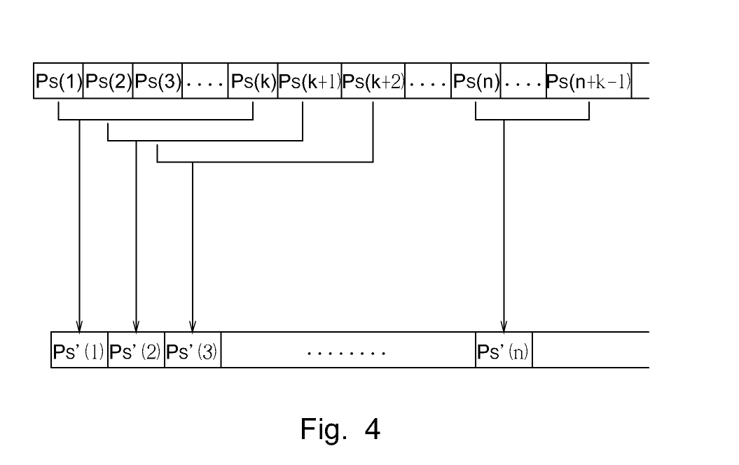

In the present embodiment, the median filters 26 and 36 select a median of a plurality of block powers inputted in a predetermined time interval, and output the selected block power corresponding to the median as output signals. For example, the input signal (i.e., block power P_{S}) of the median filter 36 comprises a plurality of block powers P_{S}(1), P_{S}(2), . . . , P_{S}(n), . . . , wherein n is the input timing. In the present embodiment, the median filter 36 selects a plurality of block powers from the input signal P_{S} by utilizing a sliding window with length k, and outputs a block power P_{S}(1)′ corresponding to the median of the selected block power. Please refer to FIG. 4 for a detailed explanation. FIG. 4 is a schematic diagram of the sliding window used by the media filter in FIG. 3. As shown in FIG. 4, the sliding window selects a plurality of block powers P_{S}(1), P_{S}(2), . . . , P_{S}(k) in a first time interval, then generates an output signal P_{S}(1)′ by selecting a median of the block powers P_{S}(1), P_{S}(2), . . . , P_{S}(k). In a second time interval, the sliding window selects the block powers P_{S}(2), P_{S}(3), . . . , P_{S}(k+1), and generates the output signal P_{S}(2)′ by selecting a median of the block powers P_{S}(2), P_{S}(3), . . . , P_{S}(k+1). Similarly, in an nth time interval, the sliding window selects the block powers P_{S}(n), P_{S}(n+1), . . . , P_{S}(n+k−1), and generates the output signal P_{S}(n)′ by selecting a median of the block powers P_{S}(n), P_{S}(n+1), . . . , P_{S}(n+k−1). The architecture of the median filter 26 is the same as the median filter 36, so a detailed description of the median filter 26 is omitted. Please note that the median filter is a prior art component having a lot of different operating methods, therefore the operating method of the median filter in the present embodiment is not limited. The median filter can also be implemented by selecting the block powers P_{S}(1), P_{S}(2), . . . , P_{S}(k) with a sliding window, and picking up an extreme value of the selected block powers P_{S}(1), P_{S}(2), . . . , P_{S}(k), then generating the output signal P_{S}(1)′ by averaging the selected block powers P_{S}(1), P_{S}(2), . . . , P_{S}(k) except for the extreme value. To sum up, any kind of prior art median filter can be used in the frequency burst detector 20 of the present invention.

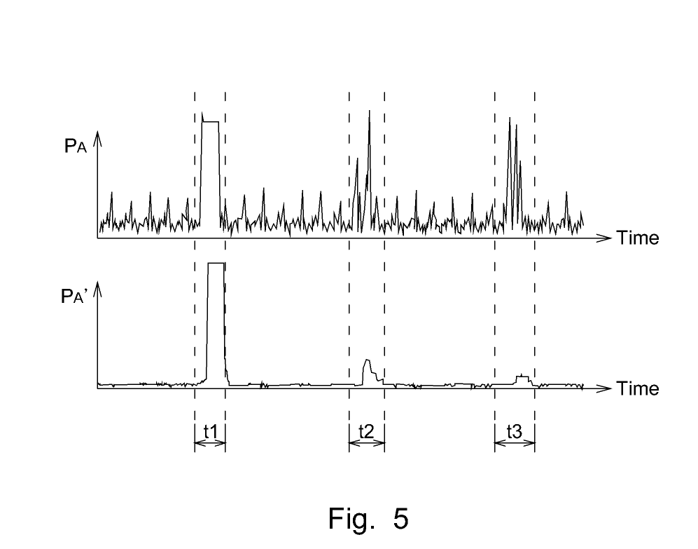

Please refer to FIG. 3 and FIG. 5. FIG. 5 is a schematic diagram of the operation of the median filter 26 shown in FIG. 3. The block power P_{A} is the input signal of the median filter 26, and the block power P_{A}′ is the output signal of the median filter 26. The received signal S comprises a frequency burst signal in the time interval t1, and comprises a non-FB signal in the time intervals t2 and t3. Although the non-FB signal still has high power after passing the band pass filter 22, the block power of the non-FB signal decreases obviously after passing the median filter 26, because the power of impulse signals of the non-FB signal are decreased by the median filter 26. Compared with the non-FB signal, the frequency burst signal remains a high block power in a time interval, and the block power P_{A}′ corresponding to the FB signal is similar to the block power P_{A} of the FB signal. Please note that the operation of median filters 26 and 36 is the same, but the input signal of the median filter 36 is different.

In conclusion, the median filters 26 and 36 are capable of decreasing the influence of a non-FB signal on the frequency burst acquisition module 28. It is obvious that the ratio of block power P_{A}′ to block power P_{S}′ in a time interval t1 is greater than a threshold value, such as 0.7, but the ratio corresponding to time intervals t2 and t3 is less than the threshold value. Consequently, the frequency burst acquisition module 28 will not give a false alarm because of any non-FB signal, therefore preventing the receiver from synchronizing by mistake and improving the efficiency of the receiver.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A receiving apparatus for receiving a signal, the receiving apparatus comprising:
a first block power calculator for evaluating a plurality of block powers of the signal;
a band pass filter for filtering the signal and outputting a specific frequency component of the signal;
a second block power calculator, electrically connected to the band pass filter, for evaluating a plurality of band-passed block powers corresponding to an output signal of the band pass filter;
a median filter module, electrically connected to the first and the second block power calculators, for outputting a first block power according to the plurality of block powers and for outputting a first band-passed block power according to the plurality of band-passed block powers; and
a frequency burst acquisition module, electrically connected to the median filter module, for determining if the signal comprises a frequency burst signal according to the first block power and the first band-passed block power to control the receiving apparatus to synchronize the signal.

2. The receiving apparatus of claim 1, wherein the median filter module comprises:
a first median filter, electrically connected to the first block power calculator, for selecting the first block power corresponding to a median of the plurality of block powers from the plurality of block powers; and
a second median filter, electrically connected to the second block power calculator, for selecting the first band-passed block power corresponding to a median of the plurality of block powers from the plurality of band-passed block powers.

3. The receiving apparatus of claim 2, wherein the first median filter selects the first block power from the plurality of block powers corresponding to a predetermined time interval, and the second median filter selects the first band-passed block power from the plurality of band-passed block powers corresponding to the predetermined time interval.

4. The receiving apparatus of claim 1, wherein the median filter module comprises:
a first computing unit, electrically connected to the first block power calculator, for computing an average of the plurality of block powers except for an extreme value of the plurality of block powers, and outputting the average as the first block power; and
a second computing unit, electrically connected to the second block power calculator, for computing an average of the plurality of band-passed block powers except for an extreme value of the plurality of band-passed block powers, and outputting the average as the first band-passed block power.

5. The receiving apparatus of claim 4, wherein the first computing unit computes the first block power according to the plurality of block powers corresponding to a predetermined time interval, and the second computing unit computes the first band-passed block power according to the plurality of band-passed block powers corresponding to the predetermined time interval.

6. The receiving apparatus of claim 1, wherein the frequency burst acquisition module is used for computing a ratio of the first band-passed block power to the first block power, and for determining that the signal comprises the frequency burst signal when the ratio is greater than a threshold value to control the receiving apparatus to synchronize the signal.

7. The receiving apparatus of claim 1 wherein the receiving apparatus is a Time Division Multiple Access (TDMA) system.

8. The receiving apparatus of claim 1, wherein the receiving apparatus is a Global System for Mobile (GSM) communications.

9. A signal synchronization method of a receiving apparatus comprising:
(a) evaluating a plurality of block powers according to a received signal;
(b) band-pass filtering the received signal for generating a specific frequency component of the received signal;
(c) evaluating a plurality of band-passed block powers according to the specific frequency component;
(d) generating a first block power according to the plurality of block powers, and generating a first band-passed block power according to the plurality of band-passed block powers; and
(e) determining if the received signal comprises a frequency burst signal according to the first block power and the first band-passed block power to control the receiving apparatus to synchronize the signal.

10. The signal synchronization method of claim 9, wherein the step (d) comprises:
selecting the first block power corresponding to a median of the plurality of block powers from the plurality of block powers; and
selecting the first band-passed block power corresponding to a median of the plurality of band-passed block powers from the plurality of band-passed block powers.

11. The signal synchronization method of claim 10, wherein the step (d) selects the first block power from the plurality of block powers corresponding to a predetermined time interval, and selects the first band-passed block power from the plurality of band-passed block powers corresponding to the predetermined time interval.

12. The signal synchronization method of claim 9, wherein the step (d) comprises:
generating the first block power by computing an average of the plurality of block powers except for an extreme value of the plurality of block powers; and
generating the first band-passed block power by computing an average of the plurality of band-passed block powers except for an extreme value of the plurality of band-passed block powers.

13. The signal synchronization method of claim 12, wherein the step (d) generates the first block power according to the plurality of block powers corresponding to a predetermined time interval, and generates the first band-passed block power according to the plurality of band-passed block powers corresponding to the predetermined time interval.

14. The signal synchronization method of claim 9, wherein the step (e) comprises:
computing a ratio of the first band-passed block power to the first block power; and
when the ratio is greater than a threshold value, determining the received signal comprises the frequency burst signal to control the receiving apparatus to synchronize the received signal.

15. The signal synchronization method of claim 9, wherein the receiving apparatus is a Time Division Multiple Access (TDMA) system.

16. The signal synchronization method of claim 9, wherein the receiving apparatus is a Global System for Mobile communications (GSM).
